(19) United States
(12) Patent Application Publication
(10) Pub. No.: US 2009/0030765 A1
(43) Pub. Date: Jan. 29, 2009

(54) Synchronising online and offline diaries

(76) Inventors: Kenneth MacDonald Cameron, Bristol (GB); Christopher Gledhill, Bristol (GB)

Correspondence Address: Kenneth Cameron, 2 Parkside Avenue, Winterbourne, Bristol, BS36 1LU, omitted

(21) Appl. No.: 12/177,870

(22) Filed: Jul. 22, 2008

(30) Foreign Application Priority Data
Jul. 24, 2007 (GB) PCT/GB07/14385

(51) Int. Cl. G06Q 30/00; G06Q 10/00; G06Q 20/00

(52) U.S. Cl. 705/8; 705/30; 705/26

(57) ABSTRACT

A apparatus and method for synchronising the online and offline diaries of sports coaches and other service providers by combining a web based interface with a mobile phone SMS gateway to provide an online booking system for their clients. The system makes use of location information and coach-client relationship rules provided by the coach to control the bookings that the client is able to make. The system is also capable of dealing with payments for lessons and other booking types.

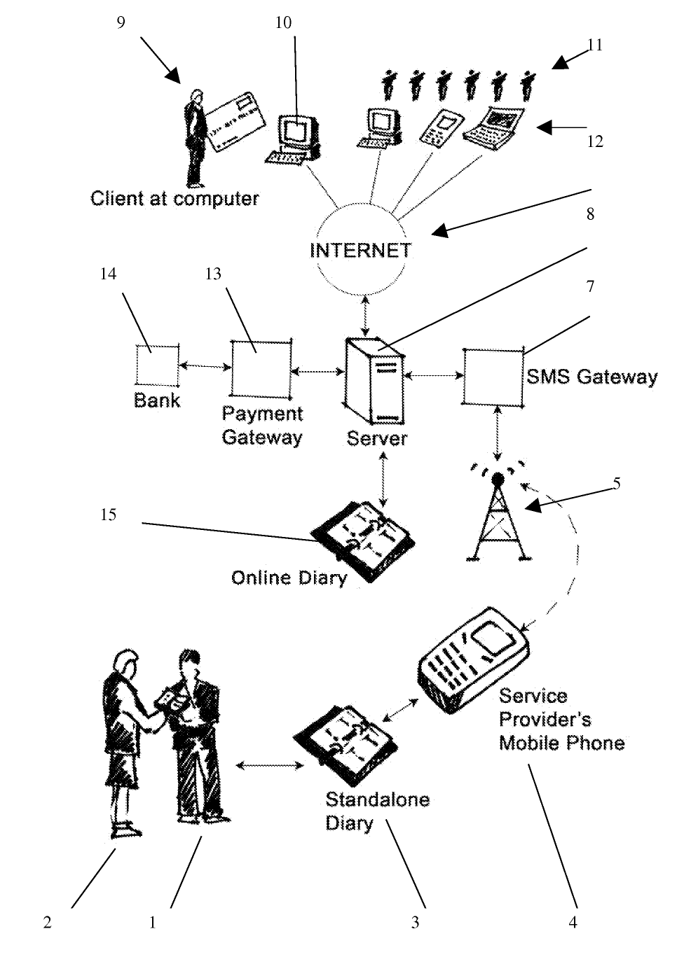

### FIELD OF THE INVENTION

The present invention relates to electronic booking systems. More particularly, the invention relates to electronic booking systems allowing instructors to maintain an electronic booking facility and a parallel booking diary. Even more particularly, the present invention relates to an electronic booking system using sms/text messages.

### BACKGROUND OF THE INVENTION

There are many coaches, instructors and other professionals offering one on one tuition/services to people in a large variety of sports and other skills. Examples range form tennis coaches and golf professionals to mobile hairdressers and masseuses. For the most part they are self-employed, operating all aspects of their business themselves. A key aspect of successful business of this type is the maintaining of a healthy diary of future bookings. Although many bookings are made by existing customers, at the conclusion of a previous booking, this does not account for all bookings. As the coaches maintain their own diaries, they are usually contacted by their clients via mobile phone. However, this is directly at odds with the need to avoid interruptions during a lesson or coaching session, during which the coach is not able to answer their phone. This often requires the coach to return calls in order to chase business and as those booking tend to also be busy people, it can result in a series of calls being needed to ‘sync up’ and confirm the booking.

The nature of the bookings, usually not at the instructor's premises and arranged by phone, can cause problems with payment. The first problem is that payment is not taken in advance and, as a result, if a client does not attend a booking, or cancels at short notice, they typically do not expect to pay, a loss the instructor typically has little choice but to accept. A second problem is the collection of payment for bookings that do take place. As they do not usually happen on the instructor's premises, the only forms of payment the instructor is able to accept are cheques or cash, both of which are rapidly being displaced by credit or debit cards.

### LIMITATIONS OF THE STATE OF THE ART

Some professionals are fortunate enough to work from a fixed location and have some support. For example a golf professional may be based at the club shop. This solves both the booking and the second of the payment problems. The diary can be maintained by the sales assistant whilst the professional is with a client, and the shop's card payment system can be used to collect payment. However there are few professionals in this position.

There are a number of online web-based booking services on the internet allowing the booking of anything from airline flights to flower deliveries. Use of such a booking system could solve both the payment problems, by taking payment on line, in advance. However, there are none that are suited to the type of professional or instructor described here, as they would require the instructor to have access to the web in order to add future bookings made by the client they are currently with. The instructor will typically only have access to a basic mobile phone whilst with the client.

An online diary also introduces an additional risk that, should it become unavailable, the instructor would not have access to his list of appointments.

### SUMMARY OF THE INVENTION

The current invention seeks to address all of the problems noted previously by providing an online internet booking system that is specifically adapted to the coach and the unique needs of other professionals.

The invention provides an electronic booking system in which booking transactions, such as new bookings, cancellations, re-arrangements etc, are carried out electronically and details of the booking are sent to the instructor via short message service/text messaging. In the preferred implementation of the invention, the system operates using a “two diaries synchronization system”. In this system and in response to receipt of a sms message relating to a booking, the coach/instructor can enter the relevant details in his personal, standalone diary at a time convenient to himself without having to interrupt an ongoing lesson or rely on a central bookings clerk or assistant. This standalone diary may be a paper or electronic version. In this way, synchronization of the electronic system and the personal diary is assured.

In addition to a web based interface allowing users to book and pay for lessons, the system incorporates a sms (short message service) based interface which allows the professional to maintain a (paper or other standalone) copy of the diary and also to make bookings whilst not having web access at the time.

To achieve this, the system sends notification messages by sms to the instructor's mobile phone whenever a lesson is booked or cancelled or rearranged. The instructor can then check for these at the end of a lesson, before making a new booking with the current client.

In a particular implementation, the system sends summary information of either new or current bookings to the coach a short time (say 5 minutes) before the end of the lesson so that the coach would be aware of his availability, and be able to offer a new booking to the current client.

In another implementation, the coach sends a correctly formatted text message to the system to reserve the next booking for the current client. This time is now reserved, unless the system replies with an sms message to the coach that this time is not available, in which case the coach can suggest and attempt to reserve an alternative time. Later on, the client can pay and thereby confirm the booking online, or in person with the coach, depending on how their relationship is set up.

The above description extends to allow a coach (or client) to receive summary updates at specified intervals (eg every Monday morning) for the week ahead, for new bookings, or to receive summary updates on request by sending a correctly formatted SMS.

One particular aspect of the invention is the maintenance of two copies of the diary. The first is held online and is accessible using a web interface on the internet. The second is a paper (or standalone electronic) version kept by the instructor. The two diaries are kept in sync by the use of mobile phone text messages.

The system sends the instructor messages when an online user modifies the diary to allow him to update his copy. Whenever the instructor wishes to alter his paper copy, he also uses a text message to update the online copy. Delivery of these messages is sufficiently immediate that it effectively allows the diaries to be kept in near realtime synchronization.

### BRIEF DESCRIPTION OF THE DRAWING

Preferred embodiments and features of the present invention will now be described with reference to the accompanying drawing, which represents schematically the components of the system and its mode of use.

### DETAILED DESCRIPTION OF THE ILLUSTRATED EMBODIMENTS

The main users of the system are the instructor 1 and his or her clients. One such client is represented at 2. He is depicted accessing an online booking facility with a view to booking or re-booking a lesson. The instructor has a standalone diary 3, which may be a paper version or other standalone (electronic) diary, PDA or the like. The instructor has a mobile telephone 4 that communicates with the internet 8 via a service provider's communication path 5, an SMS gateway 6, and a server 7.

The server 7 is also used to make payments to the instructor's account, via a payment gateway 13, into the instructor's bank 14. Other clients 1 1 may use computer terminals (eg PC's laptops, notebooks, PDAs, Blackberrys (RTM) or other devices) to book lessons and make payment into the instructor's account. One such client is indicated at 9, using a terminal 1 0 to make a payment and/or book a lesson.

In the preferred implementation of the invention, a number of features provide enhancements to the “basic” system. These features are described in the following paragraphs.

Location Processing functions

The system can recognize and process functions based on location. It allows the coaches to set up lesson types which have a location tag, and then offer availability based on location at certain times. This also allows clients to search for and find coaches based on location, not just type/price etc.

This tag will also allow certain types of lesson to be offered only at certain times if required.

### Additional SMS Functions

Sms messages may be formatted to automatically add/remove appointments to/from a calendar on the client's and the coach's mobile phones, such that the second diary becomes the mobile phone diary, rather than, or as well as, being the paper diary.

The system would also allow users to turn on/turn off sms messages. For example, if a coach is going to be away for a period of time, he or she may want to suspend receiving messages until they return.

### Appointment Processing SMS Functions

The system has functionality to allow the coach to send reminder emails and SMS messages to clients, either by group, type of client, on a time basis (the day before etc), or on an individual basis (if a certain client benefits from a reminder a couple of hours before for example). The system preferably also has functionality for clients to request reminders, based on available lesson parameters of time, location, preferred coach etc.

The system also allows the coach to auto cancel lessons based on available criteria (location, time, date, day, time span etc) for reasons such as illness or other unforeseen problems. The coach would initiate this request by sms to the system, or through the web interface, and clients would be contacted by email and/or sms with a lesson postponed or cancelled notification. The system would then credit the client with a lesson, so that it could be rescheduled, or refund monies to credit/debit card/“paypal” providers.

### Promotional/Marketing Functions of the System

In a preferred facility offered by the system, the coach may send out promotional messages, offers, deals etc en masse to his client base who have opted in (or not opted out) of promotions and offers.

The system would also allow the coach to offer discounts based on time/location/group numbers, as well as being able to vary pricing based on how near/far into the future bookings are made, and even have variable pricing/discounts based on how busy the coach is at the time being looked at by the client or potential client.

The system also gives the coach the ability to generate and distribute vouchers and voucher codes, both printed and sms based.

In addition, the system will allow coaches to offer discounts on multiple lesson purchases, to be used in a specified time period.

### General Diary Functions

The system permits all types of user to view bookings by date made, type, and any other set parameter (cost, location etc). It will also allow users to adjust the amount of diary displayed, so coaches could set how far in the future clients could book, again with variable parameters of type of lesson, client relationship etc.

It will also allow users to print out paper copies in diary format, for example formatted to fit into a filo fax or other common diary format—(week to view, month etc).

### Group Functions

The system according to the invention will allow users (both coaches and clients) to propose group lessons, and allow multiple clients to book onto these group lessons. Group lessons could incorporate multiple coaches.

The system will also allow users to send out invitations to these group lessons to clients who are registered with these coaches, or to clients whose profile suggests they may be interested in the type of group lesson proposed.

The system may also be able to offer discounts to these group lessons based on the number of clients attending.

### Blog and Community Functions

The system uses common user id's to facilitate blogs, forums and chat room facilities.

### Relationships

The system allows coaches to set up and manage relationships with users, either on an individual basis, or by adding them to groups. This relationship management may be used to set up rules to control how clients can make bookings—for example, only certain types of clients can book certain lessons (an example of this would be a beginner not being able to book onto an advanced lesson). Other examples could include: users with certain relationship attributes would not have to confirm and pay in full before a lesson (or vice versa), would be able to change appointments with less than the standard notice period, or would be able to book lessons further in advance than other users with a less trusted relationship status.

1. An apparatus for synchronising online and offline diaries comprising:
a server containing an electronic diary recording the availability of a first user and bookings of the first user's time by a plurality of second users,
a world wide web interface configured to permit internet access by the first or second users to alter the contents of the electronic diary and connected to an online payment system configured to permit the second user to pay for any booking made,
a SMS receiving interface configured to accept messages from the first user causing a booking for a second user to be made or altered in the electronic diary
and a SMS sending interface configured to send a message to the first user when a second user alters the electronic diary or makes payment, whereby to enable the offline diary to be synchronised with the electronic diary.

2. An apparatus as in claim 1,
wherein the server contains the electronic diaries of a plurality of first users
and the web interface is further configured to allow the plurality of second users to search for and make bookings with any of the first users.

3. An apparatus as in claim 2,
wherein the electronic diaries further record the location of the first users
and the web interface is further configured to constrain the type of booking made according to the location of the first users' availability at a specific time and date
and to allow the plurality of second users to search for first users by means of the locations of the first users.

4. An apparatus as in claim 3 wherein the electronic diaries further record the availability of bookings where a plurality of second users are able to participate in a shared group booking.

5. An apparatus as in claim 4,
wherein the server records a plurality of rules describing the relationship between each first user and a plurality of second users or grouping of second users
and the web interface is further configured to use the rules to constrain the types of booking each second user is able to make and the point in the booking process that payment is be made.

6. A method for synchronising online and offline diaries comprising the steps of
storing on a server an electronic diary recording the availability of a first user and bookings of the first user's time by a plurality of second users,
altering the contents of the electronic diary by using a world wide web interface configured to permit internet access,
receiving a SMS message causing a booking for a second user to be made or altered in the electronic diary,
using an online payment system to pay for any booking made,
and sending a message to the first user when a second user alters the electronic diary or makes payment, whereby to enable the offline diary to be synchronised with the electronic diary.

7. A method as in claim 6 comprising the further steps of storing the diaries of a plurality of first users on the server and using the web interface to search for the diary of a first user.

8. A method as in claim 7 comprising the further steps of recording in the electronic diaries the location of a user, using the location of the user at a specific time and date to constrain the type of booking that can be made and searching for a user by location.

9. A method as in claim 8 comprising the further steps of recording in the electronic diaries the availability of bookings where a plurality of users are able to participate in a shared group booking.

10. A method as in claim 9 further comprising the steps of storing a plurality of rules describing the relationship between each first user and a plurality of second users or group of second users and using the rules to constrain the types of booking each second user is able to make and the point in the booking process that payment is made.
